(19) United States
(12) Patent Application Publication
(10) Pub. No.: US 2008/0011019 A1
(43) Pub. Date: Jan. 17, 2008

(54) METHOD OF MANUFACTURING OPTICAL FIBER PREFORM AND METHOD OF DETERMINING DEHYDRATED CONDITION OF POROUS GLASS PREFORM

(75) Inventors: Syuhei Hayami, Tokyo (JP); Tadashi Takahashi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 11/691,660

(22) Filed: Mar. 27, 2007

(30) Foreign Application Priority Data
Mar. 30, 2006 (JP) 2006-095489

(51) Int. Cl. C03B 37/07

(52) U.S. Cl. 65/377

(57) ABSTRACT

A method of manufacturing an optical fiber preform by passing a porous glass preform through a heating area in an atmosphere of dehydration gas to dehydrate the porous glass preform is provided. Values Pcl and V are set and dehydration is performed to satisfy 0.0773×e^{7.4873×ρ}≦Pcl×T×L/V according to ρ, T, and L, where Pcl is a partial pressure of chlorine gas in the dehydration gas, T is a process temperature, L is a length of an area in the heating area where a temperature is 1150° C. or higher, V is a relative moving speed of the porous glass preform with respect to the heating area, and ρ is an average bulk density of a porous glass layer.

### CROSS-REFERENCE TO RELATED APPLICATIONS

The present document incorporates by reference the entire contents of Japanese priority document, 2006-095489 filed in Japan on Mar. 30, 2006.

### BACKGROUND OF THE INVENTION

1. Field of the Invention

The present invention relates to a method of manufacturing an optical fiber preform, which includes a dehydrating process for dehydrating a porous glass preform including a porous glass layer by passing the porous glass preform through a heating area in an atmosphere of dehydration gas, and a method of determining a dehydrating condition for the porous glass preform.

2. Description of the Related Art

A porous glass preform synthesized by a vapor-phase synthesis method, such as a vapor axial deposition method (VAD method) or an outer vapor deposition method (OVD method), is subjected to high-temperature heat treatment in an electric furnace to be transparently vitrified, and thus a transparent optical fiber preform is obtained. Conventionally, as a method of transparently vitrifying the porous glass preform, there is known a zone heating method for causing the optical fiber preform to pass through a high-temperature heating area in an atmosphere including an inert gas such as a helium gas or an inert gas containing a small amount of a halogen gas such as a chlorine gas.

Furthermore, as a method of manufacturing an optical fiber preform from which an OH group is sufficiently removed, there is a method which includes a dehydrating process and a sintering process; in the dehydrating process, a porous glass preform is heated to about 1200° C. in an inert gas atmosphere of a halogen gas or of a halogenated gas as a dehydrating agent and an OH group is removed therefrom, and then in the sintering process, the porous glass preform is heated to about 1500° C. and is sintered to be transparently vitrified.

At the same time, to reduce the manufacturing costs of optical fibers, upsizing of an optical fiber preform is demanded in recent years. To implement an upsized optical fiber preform without upsizing of manufacturing facilities, it is effective to increase a bulk density of the porous glass layer to be synthesized when the porous glass preform is manufactured using the OVD method. In the dehydrating process, however, if the porous glass preform having a porous glass layer with a high bulk density is dehydrated under the same condition as a case of the porous glass preform having a porous glass layer with a conventional bulk density, the concentration of the OH group remaining in the optical fiber preform after being transparently vitrified increases. As a result, an optical fiber made of the optical fiber preform has a high absorption peak at a wavelength of about 1380 nm, which causes a transmission loss to increase.

As a method of solving the problem, a method of determining a dehydrating condition and subjecting a porous glass preform to a dehydrating process using a zone heating method is proposed. More specifically, the dehydrating condition includes a concentration of a dehydrating agent and a traverse speed of the porous glass preform, i.e., a relative moving speed of the porous glass preform with respect to a heating area is determined from a predetermined relational expression according to the bulk density of the porous glass layer in the porous glass preform (see Japanese Patent Application Laid-Open No. 2002-104830).

In the conventional method, however, the process temperature, the length of the heating area, and the relative moving speed in the dehydrating process are not considered in the relational expression between the concentration of the dehydrating agent and the bulk density. Similarly, the concentration of the dehydrating agent and the process temperature are not considered in the relational expression between the relative moving speed, the length of the heating area, and the bulk density. In other words, the dehydrating condition cannot uniquely be determined using the conventional relational expression.

Consequently, if the bulk density of the porous glass layer in the porous glass preform to be dehydrated is changed or a specific condition of the dehydrating condition is altered, a new dehydrating condition to sufficiently remove the OH group cannot be quickly determined. Moreover, it is necessary to determine the dehydrating condition by repeatedly making a trial production which consumes the time and material, and thus, production efficiency decreases.

### SUMMARY OF THE INVENTION

It is an object of the present invention to at least partially solve the problems in the conventional technology.

A method of manufacturing an optical fiber preform, according to one aspect of the present invention, includes dehydrating a porous glass preform including a porous glass layer by passing the porous glass preform through a heating area in an atmosphere of dehydration gas. The dehydrating includes setting Pcl and V to satisfy

0.0773×e^{7.4873×ρ}≦Pcl×T×L/V

according to ρ, T, and L, where Pcl (MPa) is a partial pressure of chlorine gas in the dehydration gas, T(° C.) is a process temperature, L (mm) is a length of an area in the heating area where a temperature is 1150° C. or higher, V (mm/h) is a relative moving speed of the porous glass preform with respect to the heating area, and ρ (g/cm³) is an average bulk density of the porous glass layer.

A method of determining a dehydrating condition for a porous glass preform, according to another aspect of the present invention, includes determining Pcl and V, when dehydrating the porous glass preform including a porous glass layer by passing the porous glass preform through a heating area in an atmosphere of dehydration gas, to satisfy

0.0773×e^{7.4873×ρ}≦Pcl×T×L/V

according to ρ, T, and L, where Pcl (MPa) is a partial pressure of chlorine gas in the dehydration gas, T(° C.) is a process temperature, L (mm) is a length of an area in the heating area where a temperature is 1150° C. or higher, V (mm/h) is a relative moving speed of the porous glass preform with respect to the heating area, and ρ (g/cm³) is an average bulk density of the porous glass layer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an electric furnace used in an embodiment of the present invention;

FIG. 2 is a cross section of a porous glass preform;

FIG. 3 is a table of an average bulk density ρ, process temperature T, a length L of heating zone, a partial pressure of chlorine gas Pcl, a moving speed V, and an OH-group concentration for examples 1 to 3 and comparative examples 1 to 6 of the present invention;

FIG. 4 is a graph of a relationship between the average bulk density ρand Pcl×T×L/V for the examples 1 to 3 and the comparative examples 1 to 6; and

FIG. 5 is a graph of a relationship between Pcl×T×L/V and the OH-group concentration for the examples 1 to 3 and the comparative examples 1 to 3.

### DETAILED DESCRIPTION OF THE PREFERRED EMBODIMENTS

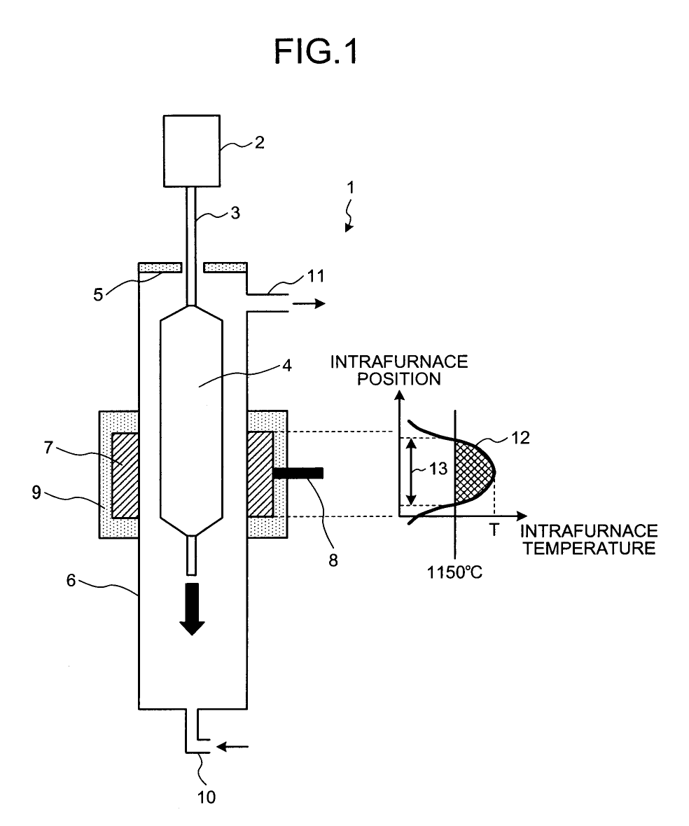

Exemplary embodiments of a method of manufacturing an optical fiber preform and a method of determining a dehydrating condition for a porous glass preform according to the present invention are explained in detail below with reference to FIGS. 1 to 5. It should be noted that the present invention is not limited by these embodiments, and thus, it is possible to change the embodiments without departing from the scope of the present invention.

An electric furnace and a porous glass preform used in a present embodiment are explained first. FIG. 1 is a schematic diagram of the electric furnace used according to the present embodiment. An electric furnace 1 includes a muffle tube 6 made of silica glass for accommodating therein a porous glass preform 4, which is held by a rotating elevator device 2 through a support rod 3; an upper cover 5 for the muffle tube 6; a heater 7 provided on an outer periphery of the muffle tube 6 to heat the porous glass preform 4 from the outside; a thermometer 8 for measuring a temperature of the heater 7; and a furnace body 9 for accommodating therein the heater 7 through a heat insulator, provided around the muffle tube 6.

The muffle tube 6 further includes a gas inlet 10 provided in the lower part thereof for supplying an inert gas, such as a helium gas or an inert gas containing a chlorine gas, into the muffle tube 6, and includes a gas outlet 11 provided in the upper part thereof for exhausting used gas to the outside of the muffle tube 6.

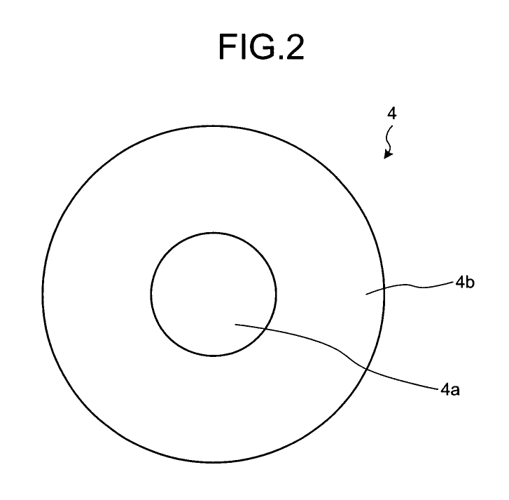

FIG. 2 is a cross section of the porous glass preform 4. The porous glass preform 4 has a core glass rod 4a including a core portion, and a porous glass layer 4b formed by being synthesized around the outside of the core glass rod 4a using the OVD method or the like. An average bulk density ρ (g/cm³) of the porous glass layer 4b is preferably 0.3 g/cm³ or more in terms of upsizing of the optical fiber preform. On the other hand, in the dehydrating process, a lower average bulk density ρ allows easier dehydration, and the dehydration becomes more difficult exponentially with higher density. Thus, the average bulk density ρ is preferably 1.0 g/cm³ or less.

The average bulk density ρ can be adjusted by a gas condition when the porous glass layer 4b is synthesized and by a speed at which flame from a burner sweeps the surface of the porous glass layer per unit time during synthesis. For example, a density ρ_{c} (g/cm³) of the porous glass layer 4b at a portion synthesized and deposited per unit time is determined. And by controlling to delay a sweep speed S (mm/sec) of the flame from the burner when the determined density ρ_{c} is lower than a target average bulk density ρ and to increase the sweep speed S of the flame from the burner when the determined density ρ_{c} is higher than the target average bulk density ρ, the average bulk density ρ can be adjusted.

The porous glass preform 4 having the porous glass layer 4b with a predetermined average bulk density ρ manufactured in the above manner is subjected to the dehydrating process and the sintering process by using the electric furnace 1 of FIG. 1. The dehydrating process is explained first.

### Dehydrating Process:

The support rod 3 connected to the upper end of the porous glass preform 4 is held by a holding portion of the rotating elevator device 2. The porous glass preform 4 is inserted into the muffle tube 6, and the muffle tube 6 is covered with the upper cover 5. The porous glass preform 4 is set at a predetermined start position, and the heater 7 is heated up to a predetermined temperature. Consequently, a heating area having a distribution curve 12 indicating an intrafurnace temperature of FIG. 1 is formed at a position with the same height as that of the heater 7 inside the muffle tube 6. The intrafurnace temperature mentioned here indicates a temperature on an axis along which the porous fiber preform moves up and down in the muffle tube 6. In the specification of the present invention, an area 13 where the temperature as shown in FIG. 1 is 1150° C. or higher in the heating area is called “heating zone”.

The temperature of the heater 7 is adjusted so that a highest intrafurnace temperature becomes a predetermined process temperature T(° C.). The highest intrafurnace temperature can be estimated from a measured value obtained by measuring the temperature of the heater 7 with the thermometer 8. The process temperature T generally ranges from 900° C. to 1300° C. If it is 1150° C. or higher, then dehydration efficiency can be increased, while if it is 1250° C. or lower, then it is possible to prevent part of the porous glass preform 4 from being sintered in the dehydrating process. By setting the process temperature T in this manner, the curve 12 is defined and the length L (mm) of the heating zone is thereby defined.

Next, the dehydration gas containing a helium gas and a chlorine gas is supplied from the gas inlet 10 into the muffle tube 6. The partial pressure of chlorine gas in a furnace atmosphere at this time is set to Pcl (Mpa). The porous glass preform 4 is lowered to the heating area at a relative moving speed V (mm/h) while being rotated, by the rotating elevator device 2. According to the present embodiment, the Pcl and V are determined to satisfy Expression (1) as follows according to ρ, T, and L.

0.0773×e^{7.4873×ρ}≦Pcl×T×L/V (1)

### By using Expression (1), the dehydrating condition for the porous glass preform to enable sufficient removal of the OH group can be speedily determined without making the trial production.

The porous glass preform 4 is caused to pass through the heating zone from its lower end thereof under the condition of the partial pressure of chlorine gas Pcl and the relative moving speed V set based on the determination, and dehydration is thereby performed. As a result, the OH group can be satisfactorily removed from the porous glass preform 4. Particularly, if the partial pressure of chlorine gas Pcl is set so that the equality is true for the predetermined relative moving speed V in Expression (1), the Pcl can be minimized under the condition under which the OH group can be sufficiently removed. Consequently, it is possible to minimize the use amount of chlorine gas and reduce material costs. Furthermore, if the relative moving speed V is set so that the equality is true for the predetermined partial pressure of chlorine gas Pcl in Expression (1), the relative moving speed V can be maximized under the condition under which the OH group can be satisfactorily removed. Consequently, it is possible to minimize the time required for the dehydrating process and reduce manufacturing time. By optimizing the material cost and the manufactured time in the above manner, the manufacturing costs can be reduced.

At a start position, the lower end portion of the porous glass preform 4 is located at a position where the intrafurnace temperature is 1000° C. or less, and the porous glass preform 4 is lowered from the position, and it is thereby possible to prevent defective appearance of the lower end portion of the manufactured optical fiber preform to occur.

If the relative moving speed V is set to 500 mm/h or less, then defective appearance can be prevented from its occurrence in the lower end portion of the manufactured optical fiber preform. On the other hand, it is preferable to set the relative moving speed V to 100 mm/h or higher in terms of preventing the increase in the manufacturing costs due to increased process time.

If the partial pressure of chlorine gas Pcl is set to 0.020 Mpa or lower, it is possible to prevent disconnection of an optical fiber when the optical fiber is drawn from a manufactured optical fiber preform and to prevent variation in optical fiber diameter. On the other hand, it is preferable to set the partial pressure of chlorine gas Pcl to 0.0010 Mpa or higher in terms of prevention of an increase in manufacturing costs due to the increase in the process time.

The porous glass preform 4 is pulled up by the rotating elevator device 2 when the upper end portion of the porous glass preform 4 passes through the heating zone where the upper end portion is satisfactorily heated, and is returned to an almost start position. The sintering process is performed next. The sintering process is explained below.

### Sintering Process:

An output of the heater 7 is adjusted so that an average intrafurnace temperature in the heating zone becomes 1500° C. to 1600° C. Next, a helium gas and a chlorine gas are supplied from the gas inlet 10 into the muffle tube 6. If sintering is performed in an atmosphere of only the helium gas, the chlorine doped in the porous glass preform 4 diffuses outward from the porous glass preform 4 in the dehydrating process, and a chlorine density distribution in the radius direction becomes nonuniform. As a result, a characteristic of the drawn optical fiber, especially a cut-off wavelength, becomes unstable, and thus, the supply amount of chlorine gas is controlled so that a partial pressure of chlorine gas in the furnace atmosphere is set to 0.003 Mpa to 0.004 Mpa.

The porous glass preform 4 is lowered to the heating area at a predetermined relative moving speed while being rotated, by the rotating elevator device 2, and is caused to pass through the heating zone from its lower end, where sintering is performed. The porous glass preform is transparently vitrified in the sintering process, to obtain a transparent optical fiber preform.

According to the present embodiment, the partial pressure of chlorine gas Pcl and the relative moving speed V are set to satisfy Expression (1) according to the average bulk density [symbol] the process temperature T, and the length L of the heating zone, and dehydration is performed. Consequently, it is possible to manufacture the optical fiber preform from which the OH-group is satisfactorily removed without decreasing the production efficiency.

### EXAMPLES 1 To 3 AND COMPARATIVE EXAMPLES 1 TO 6

As examples 1 and 2 and comparative examples 1 to 5 according to the present invention, a porous glass preform formed by synthesizing a porous glass layer around the outer periphery of a core glass rod using the OVD method was subjected to the dehydrating process and the sintering process, to manufacture an optical fiber preform. As an example 3 and a comparative example 6, a porous glass preform for core formed by synthesizing a porous glass layer containing the core using the VAD method was subjected to the dehydrating process and the sintering process, to manufacture a core glass rod. For the manufacture, the average bulk density ρ (g/cm³) of the porous glass layer, the partial pressure of chlorine gas Pcl (Mpa) in the dehydration gas during the dehydrating process, the process temperature T(° C.), the length L (mm) of the heating zone, and the relative moving speed V (mm/h) of the porous glass preform were variously changed. The concentration of the OH group in the manufactured optical fiber preform was measured.

During the dehydrating process, the dehydration gas diffuses inward in the radial direction from the outer peripheral surface of the porous glass preform. Consequently, the concentration of the OH group remaining in the optical fiber preform after the sintering process is uneven in the radial direction because it is affected by the distance from the outer peripheral surface and by the shape of a density distribution of the porous glass layer in the radial direction. Furthermore, the remaining OH group re-diffuses inward in the radial direction by the heating upon drawing of the optical fiber from the optical fiber preform. When the OH group penetrates the core portion of the optical fiber due to the rediffusion, an absorption peak due to the OH group appears at a wavelength of about 1380 nm in the transmission loss. Therefore, in the example 3 and the comparative example 6 which have comparatively low concentration, an average value of the OH-group concentration in the entire area of the core glass rod was used as the measured value of the OH-group concentration. In the examples 1 and 2 and the comparative examples 1 to 5, however, an average value of the OH-group concentration contained in a portion as follows was used as a measured value. The portion indicates up to a predetermined distance, i.e., up to 20 μm in terms of optical fiber, from an interface between the core glass rod and the porous glass layer to the outside in the radial direction.

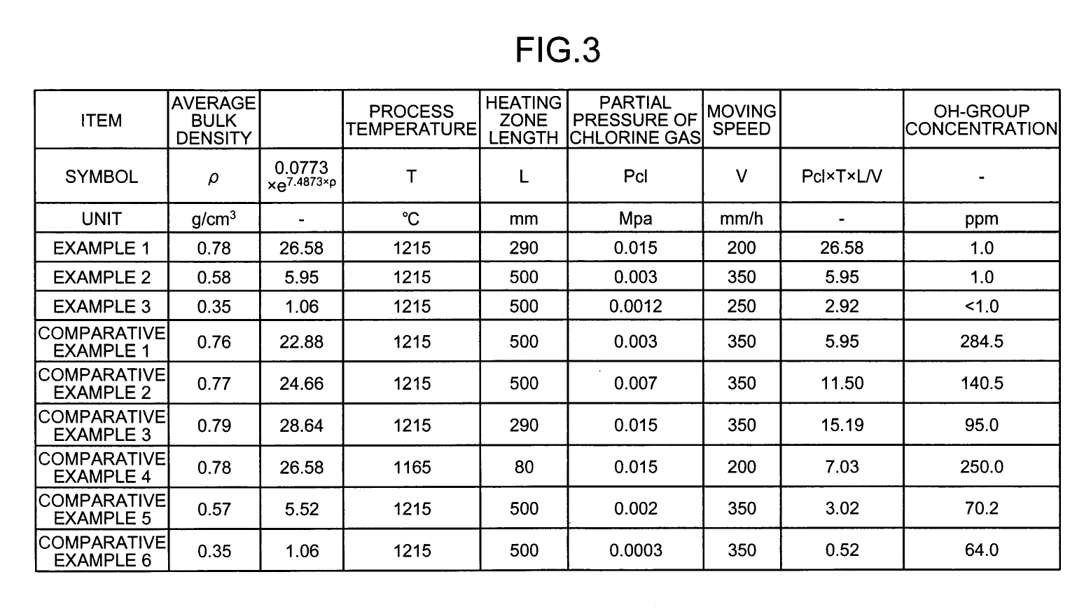

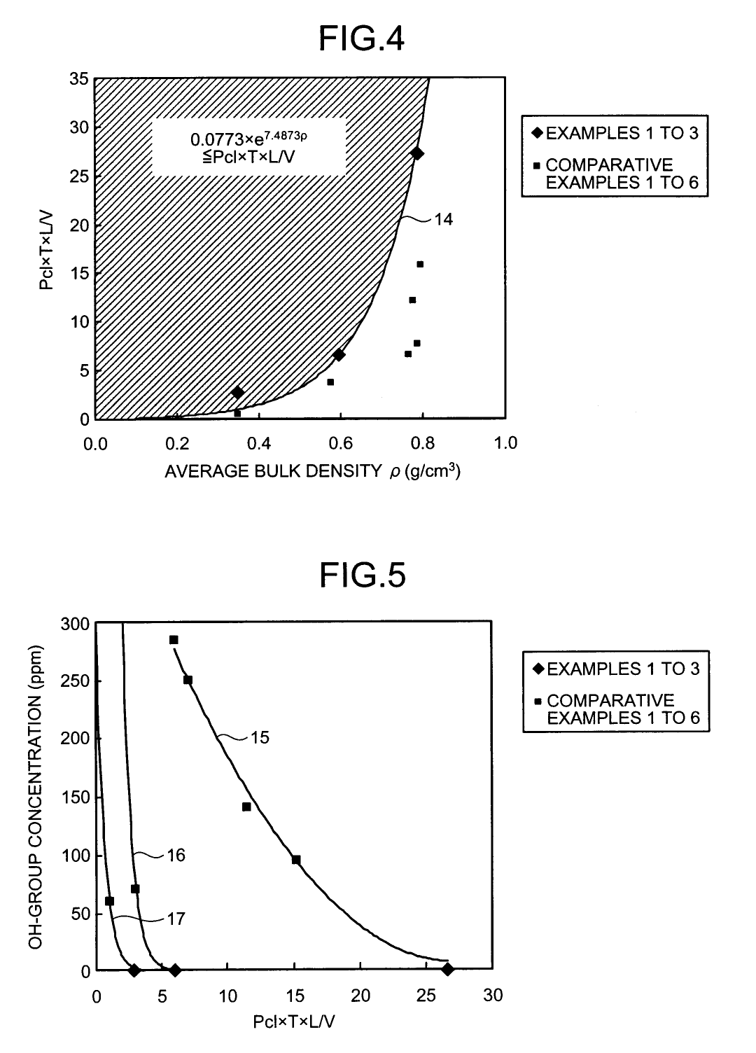

FIG. 3 is a table of the average bulk density ρ, the process temperature T, the length L of the heating zone, the partial pressure of chlorine gas Pcl, the moving speed V, and the OH-group concentration for the examples 1 to 3 and the comparative examples 1 to 6. FIG. 4 is a graph of a relationship between the average bulk density ρ and Pcl×T×L/V for the examples 1 to 3 and the comparative examples 1 to 6. A curve 14 indicates 0.0773×e^{7.4873×ρ}=Pcl×T×L/V. FIG. 5 is a graph of a relationship between Pcl×T×L/V and the OH-group concentration for the examples 1 to 3 and the comparative examples 1 to 6. In FIG. 5, curves 15 to 17 are approximate curves calculated from data points where the average bulk density ρ is 0.78 g/cm³, 0.58 g/cm³, and 0.35 g/cm³, respectively.

The example 1 is explained below with reference to FIGS. 3 to 5. The average bulk density ρ of the porous glass layer in the porous glass preform used in the example 1 was 0.78 g/cm³ as shown in FIG. 3. At the same time, the process temperature T in the electric furnace was 1215° C., and the length L of the heating zone was 290 mm. When 0.0773×e^{7.4873×ρ} is calculated for the value of the ρ, 26.58 is obtained. In the present invention, the Pcl and V are set to satisfy 0.0773×e^{7.4873×ρ}≦Pcl×T×L/V according to ρ, T, and L, and this expression represents a shaded area in FIG. 4. In the example 1, the partial pressure of chlorine gas Pcl and the moving speed V were determined to satisfy 0.0773×e^{7.4873×ρ}=Pcl×T×L/V. More specifically, as shown in FIG. 3, Pcl was set to 0.015 Mpa and V was set to 200 mm/h. As a result, the data points appear on the curve 14 of FIG. 4. The dehydrating process was performed under the condition set in this manner, and an optical fiber preform was manufactured. Consequently, as shown in FIG. 3 and FIG. 5, the OH-group concentration obtained by measuring the optical fiber preform was 1.0 ppm which is a sufficiently small value.

In the example 2 in which the average bulk density ρ was 0.58 g/cm³ and in the example 3 in which the average bulk density ρ was 0.35 g/cm³, the partial pressure of chlorine gas Pcl and the moving speed V were set in the same manner to perform the dehydrating process, and the optical fiber preform or the core glass rod was manufactured. As a result, the OH-group concentrations were 1.0 ppm and not more than 1.0 ppm respectively, which are sufficiently small values.

The comparative example 1 is explained below with reference to FIGS. 3 to 5. The average bulk density ρ of the porous glass layer in the porous glass preform used in the comparative example 1 was 0.76 g/cm³ as shown in FIG. 3. At the same time, the process temperature T in the electric furnace was 1215° C., and the length L of the heating zone was 500 mm. When 0.0773×e^{7.4873×ρ} is calculated for the value of the ρ, 22.88 is obtained. In the comparative example 1, as shown in FIG. 3, the Pcl was set to 0.003 MPa and V was set to 350 mm/h. In the case of this setting, Pcl×T×L/V is calculated to obtain 5.95, and accordingly, 0.0773×e^{7.4873×ρ}>Pcl×T×L/V. Therefore, data points appear in an area outside the shaded area in FIG. 4. As a result of performing the dehydrating process under the set condition and manufacturing an optical fiber preform, the OH-group concentration obtained by measuring the optical fiber preform was 284.5 ppm which was a very large value, as shown in FIG. 3 and FIG. 5. Likewise, respective OH-group concentrations in the other comparative examples were large values.

In the examples 1 and 2, the Pcl and V were determined to satisfy 0.0773×e^{7.4873×ρ}=Pcl×T×L/V. However, as shown in the curves 15 to 17 of FIG. 5, there is a tendency that the OH-group concentration is lower as the value of Pcl×T×L/V is greater if the average bulk densities are the same as each other. Therefore, by setting the dehydrating condition so that the data point will appear in the shaded area where 0.0773×e^{7.4873×ρ}≦Pcl×T×L/V in FIG. 4, it can be expected that the OH-group concentration not higher than the OH-group concentrations according to the examples 1 and 2 can be achieved even if the average bulk density ρ is 0.78 g/cm³ or 0.58 g/cm³.

As explained above, the method of manufacturing the optical fiber preform and the method of determining the dehydrating condition for the porous glass preform according to the present invention are suitable for use in manufacture of an optical fiber preform using a porous glass preform synthesized using the vapor-phase synthesis method.

Further effect and modifications can be readily derived by persons skilled in the art. Therefore, a more extensive mode of the present invention is not limited by the specific details and the representative embodiment. Accordingly, various changes are possible without departing from the spirit or the scope of the general concept of the present invention defined by the attached claims and the equivalent.

What is claimed is:

1. A method of manufacturing an optical fiber preform, comprising:
dehydrating a porous glass preform including a porous glass layer by passing the porous glass preform through a heating area in an atmosphere of dehydration gas, the dehydrating including setting Pcl and V to satisfy
0.0773×e^{7.4873×ρ}≦Pcl×T×L/V
according to ρ, T, and L, where Pcl (MPa) is a partial pressure of chlorine gas in the dehydration gas, T(° C.) is a process temperature, L (mm) is a length of an area in the heating area where a temperature is 1150° C. or higher, V (mm/h) is a relative moving speed of the porous glass preform with respect to the heating area, and ρ (g/cm³) is an average bulk density of the porous glass layer.

2. The method according to claim 1, wherein
the dehydration gas includes a helium gas, and
the partial pressure of chlorine gas Pcl satisfies Pcl≦0.020 MPa.

3. The method according to claim 1, wherein the process temperature T satisfies 1150° C.≦T≦1250° C.

4. The method according to claim 2, wherein the process temperature T satisfies 1150° C.≦T≦1250° C.

5. The method according to claim 1, wherein the relative moving speed V satisfies V≦500 mm/h.

6. The method according to claim 2, wherein the relative moving speed V satisfies V≦500 mm/h.

7. The method according to claim 3, wherein the relative moving speed V satisfies V≦500 mm/h.

8. The method according to claim 4, wherein the relative moving speed V satisfies V≦500 mm/h.

9. A method of determining a dehydrating condition for a porous glass preform, comprising:
determining Pcl and V, when dehydrating the porous glass preform including a porous glass layer by passing the porous glass preform through a heating area in an atmosphere of dehydration gas, to satisfy
0.0773×e^{7.4873×ρ}≦Pcl×T×L/V
according to ρ, T, and L, where Pcl (MPa) is a partial pressure of chlorine gas in the dehydration gas, T(° C.) is a process temperature, L (mm) is a length of an area in the heating area where a temperature is 1150° C. or higher, V (mm/h) is a relative moving speed of the porous glass preform with respect to the heating area, and ρ (g/cm³) is an average bulk density of the porous glass layer.
